(19) United States
(12) Patent Application Publication
(10) Pub. No.: US 2025/0336189 A1
(43) Pub. Date: Oct. 30, 2025

(54) IMAGE-TEXT DATA PROCESSING

(71) Applicant: Tencent Technology (Shenzhen) Company Limited, Shenzhen (CN)

(72) Inventors: Chulun ZHOU, Shenzhen (CN); Fandong MENG, Shenzhen (CN)

(73) Assignee: Tencent Technology (Shenzhen) Company Limited, Shenzhen (CN)

(21) Appl. No.: 19/262,045

(22) Filed: Jul. 7, 2025

Related U.S. Application Data
(63) Continuation of application No. PCT/CN2023/134353, filed on Nov. 27, 2023.

(30) Foreign Application Priority Data
Apr. 26, 2023 (CN) 202310477720.6

(51) Int. Cl. G06V 10/774; G06V 10/70; G06V 10/77; G06V 10/776

(52) U.S. Cl. CPC G06V 10/7747; G06V 10/768; G06V 10/7715; G06V 10/776

(57) ABSTRACT

In a method for training an image-text data feature extraction model, first image-text data that includes at least one first image sample and at least two text samples in different languages corresponding to the at least one first image sample is obtained. Training samples are constructed from the first image-text data, including an anchor sample, at least one positive sample corresponding to a translation of the anchor sample, and at least one negative sample including content unrelated to the anchor sample. The training samples are input into a second feature extraction model to obtain sample features. A first loss value is generated based on a semantic relevance loss with semantic relevance between the at least two text samples as a constraint. A contrastive learning loss from the sample features is generated. The model is updated based on the loss to construct a universal visio-textual representation space.

### RELATED APPLICATIONS

The present application is a continuation of International Application No. PCT/CN2023/134353, filed on Nov. 27, 2023, which claims priority to Chinese Patent Application No. 202310477720.6, filed on Apr. 26, 2023. The entire disclosures of the prior applications are hereby incorporated by reference.

### FIELD OF THE TECHNOLOGY

This application relates to the field of artificial intelligence (AI) technologies, including an image-text data processing method.

### BACKGROUND OF THE DISCLOSURE

With continuous development of AI technologies, applications of cross-modal language machine learning models are increasingly valued.

In related technologies, a cross-modal language machine learning model usually needs to be trained by using an image-text pair. For example, a developer pre-collects a multi-lingual image-text pair as training data to train a cross-modal language machine learning model. The same image corresponds to descriptive text in a plurality of languages, and the pieces of text in the plurality of languages are translations of each other.

### SUMMARY

Aspects of this disclosure include a method for training an image-text data feature extraction model, an image-text data processing method, and an apparatus. Examples of technical solutions of this disclosure may be implemented as follows:

An aspect of this disclosure provides a method for training an image-text data feature extraction model. First image-text data that includes at least one first image sample and at least two text samples in different languages corresponding to the at least one first image sample is obtained. The at least two text samples includes unrelated content. From the first image-text data, training samples including an anchor sample, at least one positive sample corresponding to a translation of the anchor sample, and at least one negative sample including content that is unrelated to content of the anchor sample are constructed. The training samples are input into a second feature extraction model to obtain sample features. A first loss value that is generated based on a semantic relevance loss with semantic relevance between the at least two text samples in the first image-text data as a semantic relevance constraint. A contrastive learning loss obtained from the sample features is generated. At least one parameter of the second feature extraction model is updated based on the first loss value. In response to a convergence condition of the second feature extraction model being satisfied, a first feature extraction model is constructed from the updated second feature extraction model. The first feature extraction model is configured to map image-text data into a universal visio-textual representation space (UVtRS).

An aspect of this disclosure provides a method for processing image-text data. The image-text data includes at least one image and at least one text sample is obtained. The image-text data is input into a first feature extraction model. A data feature of the image-text data from the first feature extraction model is obtained. The data feature is in a universal visio-textual representation space (UVtRS). The first feature extraction model is trained by obtaining first image-text data that includes at least one first image sample and at least two text samples in different languages corresponding to the at least one first image sample, the at least two text samples not being translations of each other. The first feature extraction model is trained by constructing, from the first image-text data, training samples including an anchor sample, at least one positive sample, and at least one negative sample. The first feature extraction model is trained by inputting the training samples into a second feature extraction model to obtain sample features. The first feature extraction model is trained by generating (i) a first loss value that includes a semantic relevance loss using semantic relevance between the at least two text samples in the first image-text data as a semantic relevance constraint and (ii) a contrastive learning loss obtained from the sample features. The first feature extraction model is trained by updating at least one parameter of the second feature extraction model based on the first loss value. In response to a convergence condition being satisfied, the first feature extraction model is trained by constructing the first feature extraction model from the updated second feature extraction model.

An aspect of this disclosure provides an apparatus for training an image-text data feature extraction model. The apparatus includes processing circuitry configured to obtain first image-text data that includes at least one first image sample and at least two text samples in different languages corresponding to the at least one first image sample, the at least two text samples including unrelated content. The processing circuitry is configured to construct, from the first image-text data, training samples including an anchor sample, at least one positive sample corresponding to a translation of the anchor sample, and at least one negative sample including content that is unrelated to content of the anchor sample. The processing circuitry is configured to input the training samples into a second feature extraction model to obtain sample features. The processing circuitry is configured to generate (i) a first loss value that is based on a semantic relevance loss with semantic relevance between the at least two text samples in the first image-text data as a semantic relevance constraint and (ii) a contrastive learning loss obtained from the sample features. The processing circuitry is configured to update at least one parameter of the second feature extraction model based on the first loss value. in response to a convergence condition of the second feature extraction model being satisfied, the processing circuitry is configured to construct a first feature extraction model from the updated second feature extraction model. The first feature extraction model is configured to map image-text data into a universal visio-textual representation space (UVtRS).

An aspect of this disclosure provides an image-text data processing method. The method includes: obtaining first image-text data, where the first image-text data includes at least one image and at least one piece of text; performing feature extraction on the first image-text data to map the first image-text data to a universal visio-textual representation space (UVtRS) to obtain a data feature of the first image-text data, where the UVtRS is a feature space that is constructed based on a first image-text data sample and by using semantic relevance between pieces of text in the first image-text data sample as a constraint, the first image-text data sample includes at least one first image sample and at least two text samples that are in different languages and that correspond to the first image sample, and the at least two text samples that are in different languages and that correspond to the first image sample are not translations of each other; and sending the data feature of the first image-text data to a task processing component, and outputting, by the task processing component, a processing result of a target task based on the data feature, where the target task is a classification or regression task based on image-text data.

An aspect of this disclosure provides an image-text data processing method. The method includes: constructing a first anchor sample, a first positive sample, and a first negative sample based on the first image-text data sample, where the first image-text data sample includes at least one first image sample and at least two text samples that are in different languages and that correspond to the first image sample, and the at least two text samples that are in different languages and that correspond to the first image sample are not translations of each other; inputting the first anchor sample, the first positive sample, and the first negative sample into a second feature extraction model to obtain a first sample feature output by the second feature extraction model; obtaining a first loss function value based on the first sample feature and by using semantic relevance between pieces of text in the first image-text data sample as a constraint; updating a parameter of the second feature extraction model through the first loss function value; and constructing a first feature extraction model based on the second feature extraction model in response to that the second feature extraction model satisfies a convergence condition, where the first feature extraction model is configured to process input first image-text data to obtain a data feature of the first image-text data, a processing result of a target task is output after the data feature of the first image-text data is processed by a task processing component, and the target task is a classification or regression task based on image-text data.

An aspect of this disclosure provides an image-text data processing apparatus. The apparatus includes: a data obtaining module, configured to obtain first image-text data, the first image-text data including at least one image and at least one piece of text; a feature mapping module, configured to perform feature extraction on the first image-text data to map the first image-text data to a UVtRS to obtain a data feature of the first image-text data, where the UVtRS is a feature space that is constructed based on a first image-text data sample and by using semantic relevance between pieces of text in the first image-text data sample as a constraint, the first image-text data sample includes at least one first image sample and at least two text samples that are in different languages and that correspond to the first image sample, and the at least two text samples that are in different languages and that correspond to the first image sample are not translations of each other; and a task processing module, configured to send the data feature of the first image-text data to a task processing component, and output, by the task processing component, a processing result of a target task based on the data feature, where the target task is a classification or regression task based on image-text data.

An aspect of this disclosure provides an image-text data processing apparatus. The apparatus includes: a sample construction module, configured to construct a first anchor sample, a first positive sample, and a first negative sample based on a first image-text data sample, where the first image-text data sample includes at least one first image sample and at least two text samples that are in different languages and that correspond to the first image sample, and the at least two text samples that are in different languages and that correspond to the first image sample are not translations of each other; and a sample input module, configured to input the first anchor sample, the first positive sample, and the first negative sample into a second feature extraction model to obtain a first sample feature output by the second feature extraction model; a loss calculation module, configured to obtain a first loss function value based on the first sample feature and by using semantic relevance between pieces of text in the first image-text data sample as a constraint; a parameter update module, configured to update a parameter of the second feature extraction model through the first loss function value; and a model construction module, configured to construct a first feature extraction model based on the second feature extraction model in response to that the second feature extraction model satisfies a convergence condition, where the first feature extraction model is configured to process input first image-text data to obtain a data feature of the first image-text data, a processing result of a target task is output after the data feature of the first image-text data is processed by a task processing component, and the target task is a classification or regression task based on image-text data.

An aspect of this disclosure provides a computer device. The computer device includes a processor and a memory. The memory has at least one computer program stored therein. The at least one computer program is loaded and executed by the processor to implement the foregoing image-text data processing method.

An aspect of this disclosure provides a non-transitory computer-readable storage medium, having computer-executable instructions stored therein, the computer-executable instructions, when executed by a processor, cause the processor to implement the foregoing image-text data processing method.

An aspect of this disclosure provides a computer program product. The computer program product includes a computer program. The computer program is stored in a computer-readable storage medium. A processor of a computer device reads the computer program from the computer-readable storage medium, and the processor executes the computer program, so that the computer device performs the image-text data processing method provided in various optional implementations described above.

The technical solution provided in this disclosure have the following beneficial effects:
a UVtRS is constructed by using at least one first image sample and at least two text samples that are in different languages and that correspond to the first image sample as training data, image-text data is mapped to the UVtRS when an image-text data processing task is performed, and a processing result of the task is output through a task processing component based on a data feature obtained by mapping. In the foregoing solution, according to an aspect, because the at least two text samples that are in different languages and that correspond to the first image sample are not translations of each other, multi-lingual image-text weakly-aligned data samples that have a large data volume and relatively low obtaining difficulty can be fully used, thereby extending construction data in the UVtRS, and improving accuracy of the UVtRS. According to another aspect, in a process of constructing the UVtRS, semantic relevance between pieces of text in the image-text data sample is introduced as a constraint, so that the constructed UVtRS can extract a semantic feature of input data more accurately, thereby further improving accuracy of the UVtRS constructed by using the first image sample and a corresponding text sample.

### BRIEF DESCRIPTION OF THE DRAWINGS

FIG. 1 is a schematic diagram of a system used by an image-text data processing method according to this disclosure.

FIG. 2 is a schematic diagram of strictly-aligned multi-lingual image-text involved in this disclosure.

FIG. 3 is a schematic diagram of weakly-aligned multi-lingual image-text involved in this disclosure.

FIG. 4 is a flowchart of an image-text data processing method shown in an aspect of this disclosure.

FIG. 5 is a flowchart of an image-text data processing method shown in an aspect of this disclosure.

FIG. 6 is a flowchart of an image-text data processing method shown in an aspect of this disclosure.

FIG. 7 is a schematic diagram of a network structure of a second feature extraction model involved in this disclosure.

FIG. 8 is a schematic diagram of a smooth linear interpolation method involved in this disclosure.

FIG. 9 is a schematic diagram of regularized cross-lingual visio-textual contrastive learning (R-XVtCL) involved in this disclosure.

FIG. 10 is a schematic diagram of a network structure of a second feature extraction model involved in this disclosure.

FIG. 11 is a block diagram of an image-text data processing apparatus according to an aspect of this disclosure.

FIG. 12 is a block diagram of an image-text data processing apparatus according to an aspect of this disclosure.

FIG. 13 is a structural block diagram of a computer device shown in an aspect of this disclosure.

### DETAIL DESCRIPTION

An aspect of this disclosure provides a data processing method for images and text. For ease of understanding, nouns involved in this disclosure are explained below. Further, the descriptions of the terms are provided as examples only and are not intended to limit the scope of the disclosure.

### 1) Multi-Lingual Image-Text Strictly-Aligned

The so-called multi-lingual image-text strictly-aligned means that image content and descriptive text corresponding to the image content have a high semantic relevance, and descriptive text in a plurality of languages are translations corresponding to each other. The multi-lingual image-text strictly-aligned may alternatively be referred to as semantically parallel. That is, descriptive text in a plurality of languages has the same semantics.

### 2) Multi-Lingual Image-Text Weakly-Aligned

The so-called multi-lingual image-text weakly-aligned means that image content and descriptive text corresponding to the image content have a high semantic relevance, but descriptive text in a plurality of languages may not be translations of each other. The multi-lingual image-text weakly-aligned may alternatively be referred to as semantically related but not parallel. That is, descriptive text in a plurality of languages is related to the same image, but semantics of the descriptive text in the plurality of languages are different/not the same.

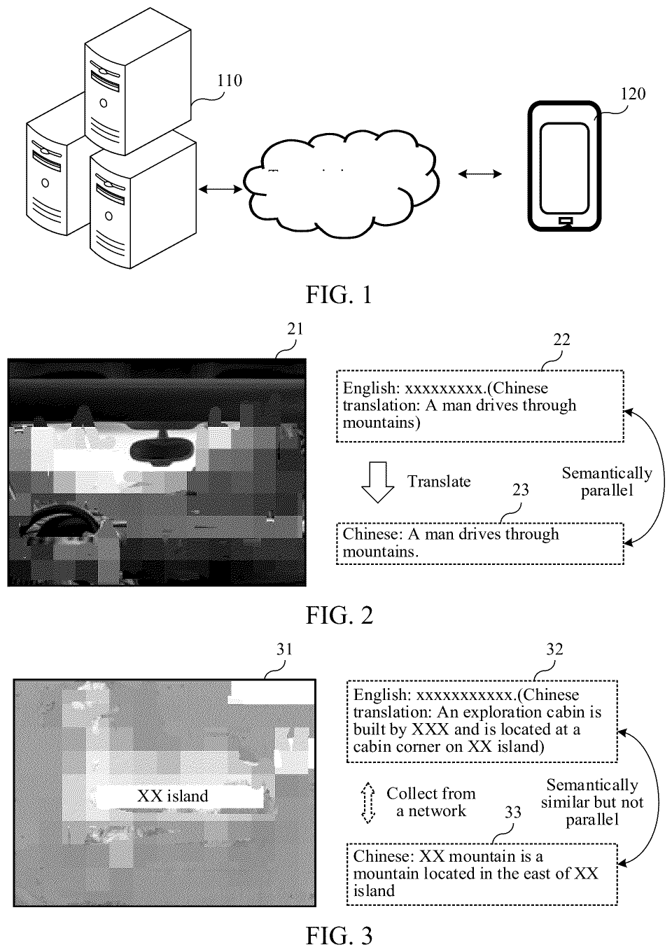

FIG. 1 shows a schematic diagram of a system used by an image-text data processing method according to an aspect of this disclosure. As shown in FIG. 1, the system includes: a server 110 and a terminal 120.

The foregoing server 110 may include a server on which an image-text data processing system is deployed and that provides an image-text data processing service for a user through the image-text data processing system, or the foregoing server 110 may include a server that has an image-text data processing system and that trains or updates the image-text data processing system.

The foregoing terminal 120 may include a user terminal that accepts an image-text data processing service, or the foregoing terminal 120 may include a development terminal used by a developer of an image-text data processing system.

For example, an image-text data processing system may alternatively be deployed in the foregoing terminal 120.

For example, the foregoing system includes one or more servers 110, and a plurality of terminals 120. Quantities of the servers 110 and the terminals 120 are not limited in this aspect of this disclosure.

The terminal is connected to the server through a communication network. For example, the communication network may be a wired network or a wireless network.

A cross-modal cross-lingual model based on an image and text has obvious advantages in multi-modal task processing. Therefore, in recent years, work of pre-training of the cross-modal cross-lingual model has attracted more and more attention. A developer mainly trains by using a multi-lingual image-text strictly-aligned image-text pair. For example, the developer may extend an English-based descriptive text in a data set of the image-text pair to a multi-lingual version in a translation mode, and design a series of cross-modal and cross-lingual pre-training tasks, so that a model can learn a better universal representation.

For example, FIG. 2 shows a schematic diagram of strictly-aligned multi-lingual image-text involved in this disclosure. As shown in FIG. 2, the strictly-aligned multi-lingual image-text includes an image 21, a piece of English text 22, and a piece of Chinese text 23. The foregoing image 21 and the English text 22 may be an image and text pre-collected by a developer, and the foregoing Chinese text 23 may be text obtained by the developer by translating the English text 22 by using a translation tool.

Subsequent aspects of this disclosure provide an improved cross-modal cross-lingual pre-training framework. The framework can effectively use a large amount of multi-lingual image-text weakly-aligned multi-modal data that exists more widely and is easier to collect. The weakly-aligned multi-lingual image-text may be collected from a network.

For example, FIG. 3 shows a schematic diagram of weakly-aligned multi-lingual image-text involved in this disclosure. As shown in FIG. 3, the weakly-aligned multi-lingual image-text includes an image 31, a piece of English text 32, and a piece of Chinese text 33. The foregoing English text 32 and Chinese text 33 are pieces of descriptive text in different languages of the image 31 that are obtained when a developer searches for the same image 31 in a network with the help of an automated retrieval tool.

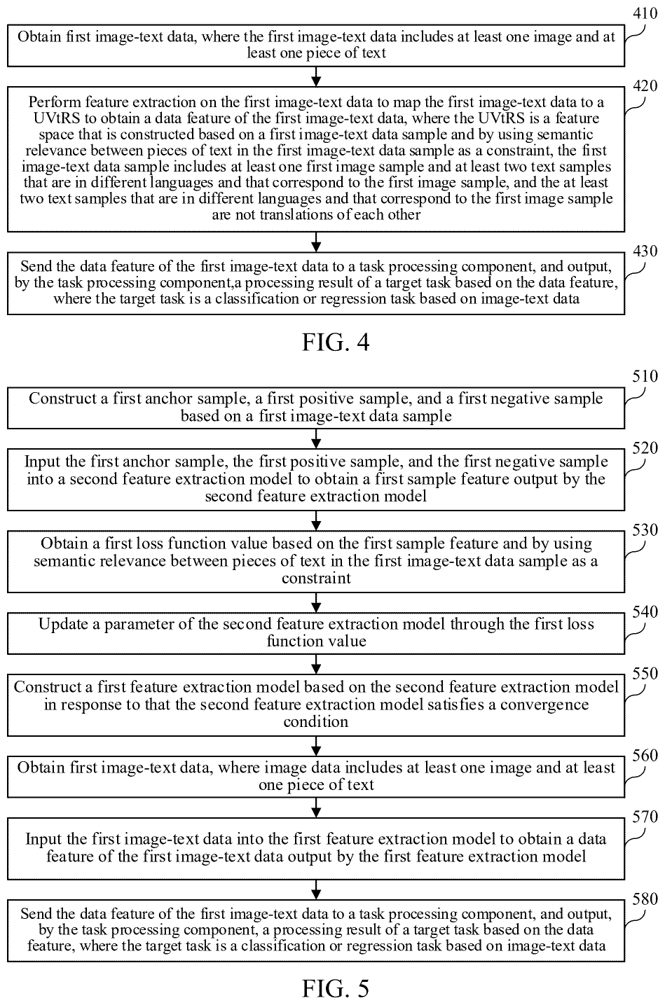

FIG. 4 is a flowchart of an image-text data processing method shown in an aspect of this disclosure. The method is performed by a computer device. The computer device may be implemented as a terminal or a server. The terminal or the server may be the terminal or the server shown in FIG. 1. As shown in FIG. 4, the image-text data processing method includes the following operations:

Operation 410: Obtain first image-text data, where the first image-text data includes at least one image and at least one piece of text. For example, the image-text data including at least one image and at least one text sample is obtained.

In this aspect of this disclosure, the foregoing first image-text data may include at least one image-text pair, and each image-text pair is an image-text pair formed by an image and a line of text.

Operation 420: Perform feature extraction on the first image-text data to map the first image-text data to a UVtRS to obtain a data feature of the first image-text data, where the UVtRS is a feature space that is constructed based on a first image-text data sample and by using semantic relevance between pieces of text in the first image-text data sample as a constraint, the first image-text data sample includes at least one first image sample and at least two text samples that are in different languages and that correspond to the first image sample, and the at least two text samples that are in different languages and that correspond to the first image sample are not translations of each other. For example, the image-text data is input into a first feature extraction model. A data feature of the image-text data from the first feature extraction model is obtained. The data feature is in a universal visio-textual representation space (UVtRS). The first feature extraction model is trained by obtaining first image-text data that includes at least one first image sample and at least two text samples in different languages corresponding to the at least one first image sample, the at least two text samples not being translations of each other.

In this aspect of this disclosure, the foregoing process of performing feature extraction on the foregoing first image-text data is a process of mapping the first image-text data to the UVtRS to obtain a data feature of the first image-text data. Or, the operation of mapping the first image-text data to the UVtRS is implemented by performing feature extraction on the first image-text data.

In machine learning, after feature mapping is performed on input raw data for one or more times, a higher-dimensional abstract expression is obtained. The abstract expression may be referred to as a feature of the raw data in a machine learning concept. A space formed by features obtained after feature mapping is performed on all possible input data for one or more times is a feature space. In other words, features in the feature space are higher-dimensional expressions of all possible input data.

The foregoing UVtRS is a feature space configured for uniformly representing two types of data, namely, an image and text.

In this aspect of this disclosure, two different types of data, that is, the image and the text, may be fused into a universal feature space (that is, the foregoing UVtRS). The data feature obtained by mapping the first image-text data to the UVtRS may be represented in a form such as a feature vector or a feature matrix.

That the UVtRS is constructed based on the first image-text data sample and by using semantic relevance between pieces of text in the first image-text data sample as a constraint may refer to: when the UVtRS is constructed based on the first image-text data sample, the UVtRS is constructed to reduce a semantic distance (or improving semantic relevance) between pieces of text in the first image-text data sample.

The at least two text samples that are in different languages and that correspond to the first image sample may mean that one first image sample corresponds to at least two text samples, and the at least two text samples respectively belong to different languages (for example, respectively belong to Chinese, English, and French), and semantics of the at least two text samples are related to the first image sample.

In addition, that the at least two text samples that are in different languages and that correspond to the first image sample are not translations of each other may mean that semantic features of the at least two text samples that are in different languages and that correspond to the first image sample are different. For example, after being translated into the same language, semantic extraction is performed on each of the at least two text samples that are in different languages and that correspond to the first image sample to obtain semantic feature vectors of the at least two text samples in different languages after translation, and then a similarity between the semantic feature vectors is calculated. If the similarity between any two of the semantic feature vectors is not greater than a similarity threshold, it may be considered that the at least two text samples that are in different languages and that correspond to the first image sample are not translations of each other. For another example, after being translated into the same language, keyword extraction is performed on each of the at least two text samples that are in different languages and that correspond to the first image sample to obtain keywords of the at least two text samples in different languages after translation. If the at least two text samples in different languages after translation are different, it may be considered that the at least two text samples that are in different languages and that correspond to the first image sample are not translations of each other.

For example, it is assumed that image content of a first image sample is “there is a house under a mountain, and there are two puppies in front of the house”, the first image sample has two text samples, where one text sample of Chinese is “there is a house under a mountain”, and the other sample of English is “there are two puppies in front of the house”. Semantics of the two text samples are related to the first image sample, but semantic features/keywords extracted after the two text samples are translated into the same language are different, that is, the two text samples are not translations of each other.

The first image-text data sample may be a multi-lingual image-text weakly-aligned data sample.

Operation 430: Send the data feature of the first image-text data to a task processing component, and output, by the task processing component, a processing result of a target task based on the data feature, where the target task is a classification or regression task based on image-text data. For example, the data feature of the image-text data is processed through a task processing component. A processing result of a target task is output based on the data feature. The target task includes a classification task or a regression task based on the image-text data.

The foregoing task processing component may be a software module (a machine learning model) disposed in a current computer device. In this case, the computer device may input the foregoing data feature obtained by mapping into the task processing component.

Or, the foregoing task processing component may be a software module disposed in another computer device apart from the current computer device. In this case, the computer device may send the foregoing data feature to the another computer device through a wired/wireless network, and the another computer device inputs the data feature into the task processing component.

In this aspect of this disclosure, the data feature obtained by mapping the first image-text data to the UVtRS in operation 420 may be configured for any subsequent classification task or regression task implemented based on the image and the text.

The foregoing classification task refers to a task of outputting a classification probability after the foregoing data feature is processed. The foregoing regression task refers to a task of outputting an image/text/an image-text pair or outputting another data feature after the foregoing data feature is processed.

For example, the foregoing data feature obtained by mapping the first image-text data to the UVtRS is processed by the task processing component to output a classification probability (for example, a probability of whether the image matches the text, or a probability of whether the image belongs to a type), output a regression result (for example, output a reconstructed image, or output reconstructed/translated text), or the like. The classification task or regression task implemented based on the image and the text is not limited in this aspect of this disclosure.

In conclusion, in the solution shown in this aspect of this disclosure, a UVtRS is constructed by using at least one first image sample and at least two text samples that are in different languages and that correspond to the first image sample as training data, image-text data is mapped to the UVtRS when an image-text data processing task is performed, and a processing result of the task is output through a task processing component based on a data feature obtained by mapping. In the foregoing solution, according to an aspect, because the at least two text samples that are in different languages and that correspond to the first image sample are not translations of each other, multi-lingual image-text weakly-aligned data samples that have a large data volume and relatively low obtaining difficulty can be fully used, thereby extending construction data in the UVtRS, and improving accuracy of the UVtRS. According to another aspect, in a process of constructing the UVtRS, semantic relevance between pieces of text in the image-text data sample is introduced as a constraint, so that the constructed UVtRS can extract a semantic feature of input data more accurately, thereby further improving accuracy of the UVtRS constructed by using the first image sample and a corresponding text sample.

In the aspect shown in FIG. 2, the foregoing UVtRS may be represented by using a machine learning model. After the machine learning model is trained through training data formed by an image-text pair in advance, subsequently input image-text data may be processed to obtain a data feature of the image-text data in the foregoing UVtRS.

Based on the aspect shown in FIG. 4, refer to FIG. 5, which is a flowchart of an image-text data processing method shown in an aspect of this disclosure. The method is performed by a computer device. The computer device may be implemented as a terminal or a server. The terminal or the server may be the terminal or the server shown in FIG. 1. As shown in FIG. 5, training and application processes of a machine learning model configured for image-text data processing may include the following operations:

Operation 510: Construct a first anchor sample, a first positive sample, and a first negative sample based on a first image-text data sample. For example, from the first image-text data, training samples including an anchor sample, at least one positive sample, and at least one negative sample are constructed.

The first image-text data sample includes at least one first image sample and at least two text samples that are in different languages and that correspond to the first image sample, and the at least two text samples that are in different languages and that correspond to the first image sample are not translations of each other.

In this aspect of this disclosure, a developer may collect a weakly-aligned image-text data sample (that is, the first image-text data sample) in advance, and then construct a sample required for contractive learning based on the first image-text data sample, including a first anchor sample used as an anchor, a first positive sample used as a positive sample, and a first negative sample used as a negative sample.

The first positive sample refers to a sample matching the first anchor sample feature, and the first negative sample refers to a sample mismatching the first anchor sample feature.

For example, when the first anchor sample includes an image-text pair, each of the first positive sample and the first negative sample may include an image-text pair. A relationship between an image and text in the first positive sample is similar to a relationship between an image and text in the first anchor sample, and a relationship between an image and text in the first negative sample is not similar to a relationship between an image and text in the first anchor sample.

For example, each of the first anchor sample, the first positive sample, and the first negative sample includes the same image, and each of the first anchor sample, the first positive sample, and the first negative sample includes different text. The text in the first anchor sample and the text in the first positive sample are different, but semantics of the two pieces of text are similar to semantics of the image, and semantics of the text in the first negative sample are not similar to or not related to the semantics of the image.

For another example, when the first anchor sample includes one pieces of text, each of the first positive sample and the first negative sample may include one piece of text. In addition, the semantics of the text in the first positive sample is similar to the semantics of the text in the first anchor sample, and the semantics of the text in the first negative sample is not similar to the semantics of the text in the first anchor sample.

Operation 520: Input the first anchor sample, the first positive sample, and the first negative sample into a second feature extraction model to obtain a first sample feature output by the second feature extraction model. For example, the training samples are input into a second feature extraction model to obtain sample features.

In this aspect of this disclosure, the computer device may input each of the first anchor sample, the first positive sample, and the first negative sample into the second feature extraction model, and the second feature model processes each of the first anchor sample, the first positive sample, and the first negative sample to output sample features of the first anchor sample, the first positive sample, and the first negative sample. The sample features of the first anchor sample, the first positive sample, and the first negative sample may form the first sample feature.

Operation 530: Obtain a first loss function value based on the first sample feature and by using semantic relevance between pieces of text in the first image-text data sample as a constraint. For example, a first loss value that includes a semantic relevance loss using semantic relevance between the at least two text samples in the first image-text data as a semantic relevance constraint is generated. A contrastive learning loss obtained from the sample features is generated.

In this aspect of this disclosure, when generating the first loss function value based on the first sample feature, the computer device may consider the semantic relevance between pieces of text in the first image-text data sample. That is, the computer device may generate the first loss function value with reference to two types of information, that is, the first sample feature and semantic relevance information between pieces of text in the foregoing first image-text data sample.

The foregoing semantic relevance information between the pieces of text in the first image-text data sample may be calculated based on the first sample feature. For example, the computer device may process according to features related to text in the first anchor sample, the first positive sample, and the first negative sample in the first sample features to obtain semantic relevance information between pieces of text in the first anchor sample, the first positive sample, and the first negative sample.

The foregoing semantic relevance may refer to a semantic similarity between two or more pieces of text.

A process that the computer device obtains the first loss function value based on the first sample feature and by using semantic relevance between pieces of text in the first image-text data samples as a constraint may include:

the computer device generates one part of loss function value based on the first sample feature in a contrastive learning mode, then generates another part of loss function value based on the semantic relevance information, and then adds or performs weighted summation on the two parts of loss function value to obtain the first loss function value.

Operation 540: Update a parameter of the second feature extraction model through the first loss function value. For example, at least one parameter of the second feature extraction model is updated based on the first loss value.

In this aspect of this disclosure, because the process of calculating the first loss function value considers the semantic relevance information between text in the first anchor sample, the first positive sample, and the first negative sample, training using a weakly-aligned image-text data sample can be supported, so that the training data available for the second feature extraction model can be extended to the weakly-aligned image-text data sample, thereby extending the training data of the model. More training data helps to improve model training accuracy.

Operation 550: Construct a first feature extraction model based on the second feature extraction model in response to that the second feature extraction model satisfies a convergence condition. For example, in response to a convergence condition being satisfied, the first feature extraction model is constructed from the updated second feature extraction model.

The first feature extraction model is configured to process input first image-text data input to obtain a data feature of the first image-text data, and the task processing component outputs a processing result of the target task after the data feature of the first image-text data is processed. The target task is a classification or regression task based on image-text data.

That is, the first feature extraction model is a machine learning network constructed based on the second feature extraction model. The second feature extraction model is a machine learning model obtained by performing machine learning training based on a first image-text data sample and by using semantic relevance between pieces of text in the first image-text data sample as a constraint.

In a possible implementation, the second feature extraction model may be directly used as the first feature extraction model for application deployment for feature extraction of image-text data.

In another possible implementation, a developer may alternatively improve the foregoing second feature extraction model through a computer device, and use the improved second feature extraction model as the first feature extraction model for application deployment for extracting a feature of image-text data.

For example, the developer may optimize the second feature extraction model through the computer device to obtain the foregoing first feature extraction model. For example, the developer may re-train the second feature extraction model through the computer device, so that the second feature extraction model is more suitable for a particular image-text data processing service. For another example, the developer may simplify (for example, pruning or distilling) the second feature extraction model through the computer device to obtain a lightweight first feature extraction model, thereby improving a model processing speed.

Operation 560: Obtain first image-text data, where the first image-text data includes at least one image and at least one piece of text. For example, the image-text data including at least one image and at least one text sample is obtained.

After application deployment of the first feature extraction model, the computer device on which the first feature extraction model is deployed may execute an image-text data processing task. In this case, the computer device may obtain to-be-processed first image-text data.

In a possible implementation, the foregoing first image-text data may include several image-text pairs.

Operation 570: Input the first image-text data into the first feature extraction model to obtain a data feature of the first image-text data output by the first feature extraction model. For example, the image-text data is input into a first feature extraction model. A data feature of the image-text data is obtained from the first feature extraction model. The data feature is in a universal visio-textual representation space (UVtRS).

The foregoing first feature extraction model is configured to map a feature of input image-text data to a UVtRS.

In a possible implementation, the computer device may belong a plurality of image-text pairs in the first image-text data to the first feature extraction model, so that the first feature extraction model processes the image-text pairs, and outputs a data feature of the first image-text data.

Operation 580: Send the data feature of the first image-text data to a task processing component, and output, by the task processing component, a processing result of a target task based on the data feature, where the target task is a classification or regression task based on image-text data. For example, the data feature of the image-text data is processed through a task processing component. A processing result of a target task is output based on the data feature. The target task includes a classification task or a regression task based on the image-text data.

The foregoing aspect relates to a training process of the second feature extraction model (operation 510 to operation 540), a constructing process of the first feature extraction model (operation 550), and an application process of the first feature extraction model (operation 560 to operation 580). The foregoing three processes may be respectively performed by different computer devices. Or, two of the foregoing three processes may be performed by one computer device, and another process may be performed by another computer device. Or, the foregoing three processes may be performed by the same computer device.

In this aspect of this disclosure, the computer device maps input first image-text data to a UVtRS by using a pre-trained first feature extraction model, thereby improving accuracy of feature mapping, and further improving accuracy of a processing result of a subsequent target task.

In this aspect of this disclosure, the computer device may train the second feature extraction model in a mode of contrastive learning based on the first anchor sample, the first positive sample, and the first negative sample constructed based on the first image-text data sample.

In a possible implementation, the foregoing first anchor sample includes a first anchor image-text sample and a first anchor text sample. The first positive sample includes at least one first positive image-text sample and at least one first positive text sample. The first negative sample includes at least one first negative image-text sample and at least one first negative text sample.

Each of the first anchor image-text sample, the first positive image-text sample, and the first negative image-text sample includes an image-text pair, and the first anchor image-text sample, the first positive image-text sample, and the first negative image-text sample include the same first image. Text in the first positive image-text sample and text in the first anchor image-text sample separately semantically match the first image, and text in the first negative image-text sample does not semantically match the first image. The first anchor text sample includes the text in the first anchor image-text sample, the first positive text sample includes the text in the first positive image-text sample, and the first negative text sample includes the text in the first negative image-text sample.

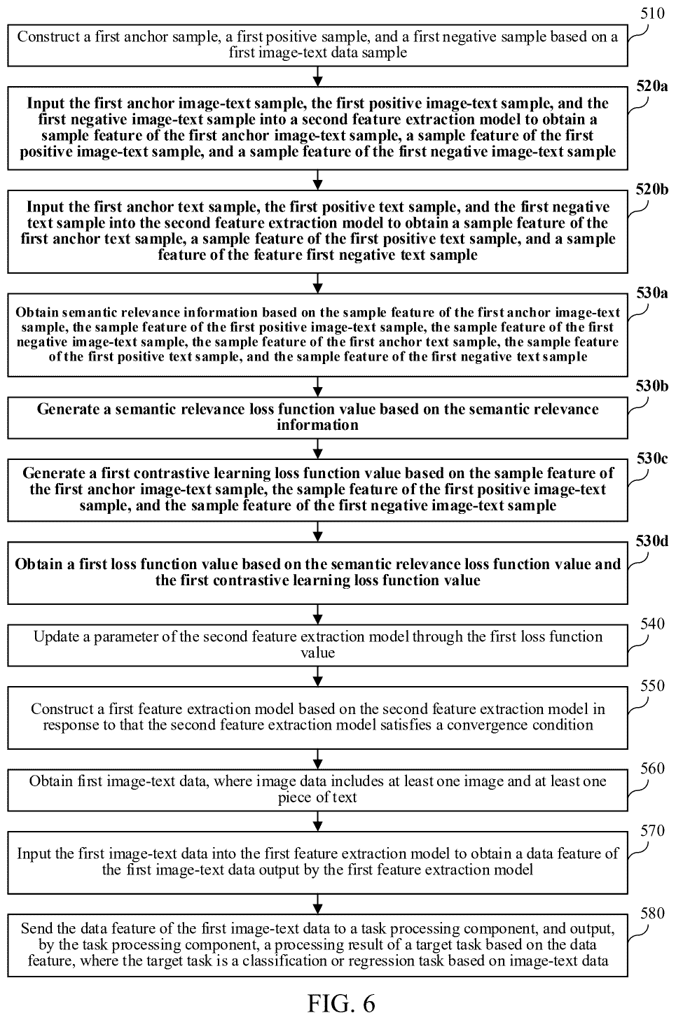

Based on the aspect shown in FIG. 5, refer to FIG. 6, which is a flowchart of an image-text data processing method according to an aspect of this disclosure. As shown in FIG. 6, operation 520 in the aspect shown in FIG. 5 may be implemented as operation 520a and operation 520b, and operation 530 may be implemented as operation 530a to operation 530d.

Operation 520a: Input the first anchor image-text sample, the first positive image-text sample, and the first negative image-text sample into a second feature extraction model to obtain a sample feature of the first anchor image-text sample, a sample feature of the first positive image-text sample, and a sample feature of the first negative image-text sample. For example, the first anchor image-text sample, the at least one first positive image-text sample, and the at least one first negative image-text sample are input into the second feature extraction model to obtain a sample feature of the first anchor image-text sample, a sample feature of the at least one first positive image-text sample, and a sample feature of the at least one first negative image-text sample.

In this aspect of this disclosure, the computer device configured to train the second feature extraction model may input each of the first anchor image-text sample, the first positive image-text sample, and the first negative image-text sample into the second feature extraction model, and the second feature extraction model outputs sample features of the first anchor image-text sample, the first positive image-text sample, and the first negative image-text sample.

In a possible implementation, the foregoing second feature extraction model may include at least one feature extraction network. When at least two feature extraction networks are included, network structures and parameters of the at least two feature extraction networks may be the same, or may be different. For example, all or some networks in the at least two feature extraction networks may be sequentially connected, may be connected in a residual mode, may be connected in a cross mode, may be connected in a cyclic mode, or the like. A connection mode between the foregoing feature extraction networks is not limited in this aspect of this disclosure.

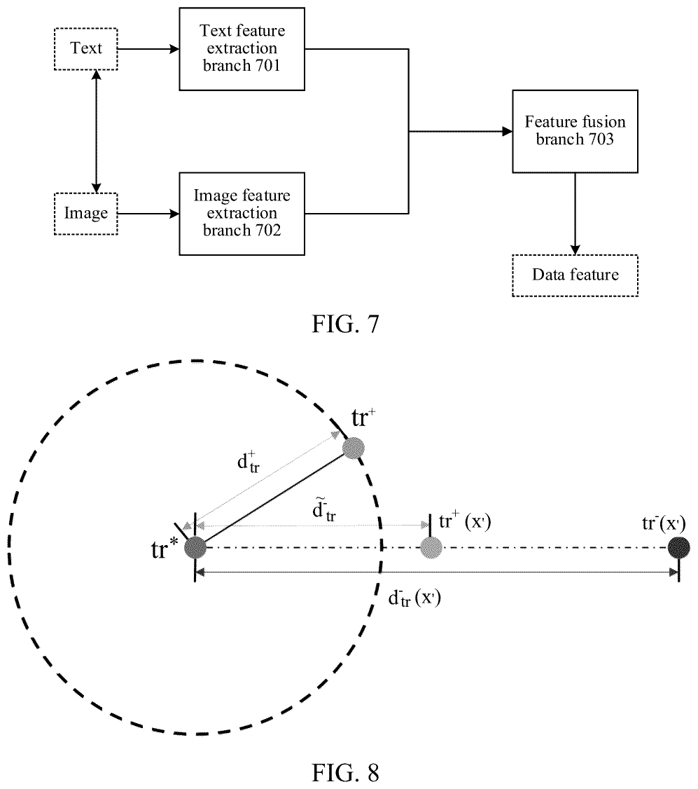

FIG. 7 shows a schematic diagram of a network structure of a second feature extraction model involved in an aspect of this disclosure. As shown in FIG. 7, the second feature extraction model is classified according to functions, and may be divided into a text feature extraction branch 701, an image feature extraction branch 702, and a feature fusion branch 703. After the computer device inputs an image-text pair into the second feature extraction model, an image (or an image sample) in the image-text pair (or an image-text sample pair) is input into the image feature extracting branch 702 to obtain an image feature (or an image sample feature). Text (or a text sample) in the image-text pair (or the image-text sample pair) is input into the text feature extracting branch 701 to obtain a text feature (or a text sample feature). The foregoing image feature (or the image sample feature) and the text feature (or the text sample feature) are input into the feature fusion branch 703 to obtain a data feature (or a data sample feature) output by the model.

FIG. 7 merely shows a possible network structure of the second feature extraction model as an example. In an example, the foregoing second feature extraction model may alternatively use another structure, for example, another connection structure or another network branch division mode.

Operation 520b: Input the first anchor text sample, the first positive text sample, and the first negative text sample into the second feature extraction model to obtain a sample feature of the first anchor text sample, a sample feature of the first positive text sample, and a sample feature of the feature first negative text sample. For example, the first anchor text sample, the at least one first positive text sample, and the at least one first negative text sample are input into the second feature extraction model to obtain a sample feature of the first anchor text sample, a sample feature of the at least one first positive text sample, and a sample feature of the at least one first negative text sample.

In this aspect of this disclosure, the foregoing second feature extraction model may include a text feature extraction network (for example, the text feature extraction branch 701 in FIG. 7). The computer device may input each of the first anchor text sample, the first positive text sample, and the first negative text sample into the foregoing text feature extraction network to obtain sample features of the first anchor text sample, the first positive text sample, and the first negative text sample.

Operation 530a: Obtain semantic relevance information based on the sample feature of the first anchor image-text sample, the sample feature of the first positive image-text sample, the sample feature of the first negative image-text sample, the sample feature of the first anchor text sample, the sample feature of the first positive text sample, and the sample feature of the first negative text sample. The semantic relevance information is configured for indicating semantic relevance between pieces of text in the first image-text data sample. For example, semantic relevance information is obtained based on the sample feature of the first anchor image-text sample, the sample feature of the at least one first positive image-text sample, the sample feature of the at least one first negative image-text sample, the sample feature of the first anchor text sample, the sample feature of the at least one first positive text sample, and the sample feature of the at least one first negative text sample. The semantic relevance information indicates the semantic relevance between the at least two text samples in the first image-text data.

In the foregoing aspect, the sample features of the first anchor text sample, the first positive sample text sample, and the first negative text sample are text-related features. The sample features of the first anchor image-text sample, the first positive image-text sample, and the first negative image-text sample alternatively include some text-related features. In this way, the computer device may calculate the semantic relevance between the pieces of text in the first image-text data sample with reference to the sample feature of the image-text sample and the sample feature of the text sample.

Operation 530b: Generate a semantic relevance loss function value based on the semantic relevance information. For example, the semantic relevance loss is generated based on the semantic relevance information.

In a possible implementation, that the semantic relevance information is obtained based on the sample feature of the first anchor image-text sample, the sample feature of the first positive image-text sample, the sample feature of the first negative image-text sample, the sample feature of the first anchor text sample, the sample feature of the first positive text sample, and the sample feature of the first negative text sample includes:
normalization processing is performed on the sample feature of the first anchor image-text sample, the sample feature of the first positive image-text sample, and the sample feature of the first negative image-text sample to obtain first relevance distribution information in the semantic relevance information; and
normalization processing is performed on the sample feature of the first anchor text sample, the sample feature of the first positive text sample, and the sample feature of the first negative text sample to obtain second relevance distribution information in the semantic relevance information.

In this aspect of this disclosure, the computer device may calculate semantic-related relevance distribution information of each data type in a normalization processing mode according to a data type (image-text data or pure text data) corresponding to the feature. For example, the computer device may calculate the semantic-related relevance distribution information of the image-text data according to the sample features of the first anchor image-text sample, the first positive image-text sample, and the first negative image-text sample. In addition, the computer device may further calculate the semantic-related relevance distribution information of the pure text data according to the sample features of the first anchor text sample, the first positive sample text sample, and the first negative text sample. The two types of relevance distribution information form the foregoing semantic relevance information.

The generating the semantic relevance loss function value based on the semantic relevance information includes: a KL divergence is calculated for the first relevance distribution information and the second relevance distribution information to obtain the semantic relevance loss function value.

In this aspect of this disclosure, the computer device may calculate the KL divergence between the first relevance distribution information and the second relevance distribution information to fuse the first relevance distribution information and the second relevance distribution information into semantic relevance loss function value to represent semantic relevance between the pieces of text in the first image-text data sample to construct a loss function value related to the semantic relevance, thereby extending training data available for the second feature extraction model to a weakly-aligned image-text data sample.

Or, the computer device may obtain the semantic relevance information in another mode. For example, the computer device may first fuse the sample feature of the first anchor image-text sample and the sample feature of the first anchor text sample. For example, after the sample feature of the first anchor image-text sample and the sample feature of the first anchor text sample are concatenated, fusion processing is performed through a fusion network (for example, the fusion network may include a fully connected layer, a convolutional layer, or a pooling layer) to obtain a fusion anchor sample feature. Similarly, the computer device may fuse the sample feature of the first positive image-text sample and the sample feature of the first positive text sample to obtain a fusion positive sample feature. The computer device may fuse the sample feature of the first negative image-text sample and the sample feature of the first negative text sample to obtain a fusion negative sample feature. Then, the computer device calculates the foregoing semantic relevance information based on the fusion anchor sample feature, the fusion positive sample feature, and the fusion negative sample feature. In this case, the computer device may calculate the semantic relevance loss function value through the foregoing semantic relevance information.

Operation 530c: Generate a first contrastive learning loss function value based on the sample feature of the first anchor image-text sample, the sample feature of the first positive image-text sample, and the sample feature of the first negative image-text sample. For example, the contrastive learning loss is generated based on the sample feature of the first anchor image-text sample, the sample feature of the at least one first positive image-text sample, and the sample feature of the at least one first negative image-text sample.

In this aspect of this disclosure, in addition to the semantic relevance loss function value, the computer device may further generate the first contrastive learning loss function value in a contrastive learning mode with reference to the sample feature of the first anchor image-text sample, the sample feature of the first positive image-text sample, and the sample feature of the first negative image-text sample to improve accuracy of subsequent model training.

Operation 530d: Obtain a first loss function value based on the semantic relevance loss function value and the first contrastive learning loss function value. For example, the first loss value is obtained based on the semantic relevance loss and the contrastive learning loss.

In this aspect of this disclosure, the computer device may calculate the first loss function value with reference to the semantic relevance loss function value and the first contrastive learning loss function value. For example, the computer device may add or perform weighted summation on the semantic relevance loss function value and the first contrastive learning loss function value to obtain the first loss function value. A weight of the weighted summation may be preset by a developer.

In the solution shown in this aspect of this disclosure, the computer device may calculate the semantic relevance loss function value through the input text-related sample feature, then obtain the first loss function value with reference to a contrastive learning loss function value, and further update a parameter of the second feature extraction model through the first loss function value, so as to use the semantic relevance between the pieces of text in the first image-text data sample as a constraint and fuse the constraint to a model training process. In this way, the training data available for the second feature extraction model can be extended to the weakly-aligned image-text data sample, thereby extending the training data of the model. More training data helps to improve model training accuracy.

In a possible implementation, the foregoing method further includes:
a second loss function value is generated based on the sample feature of the first anchor text sample, the sample feature of the first positive text sample, and the sample feature of the first negative text sample; and
a parameter of the second feature extraction model is updated through the second loss function value.

In this aspect of this disclosure, the computer device may alternatively update the parameter of the second feature extraction model by separately using the sample feature of the text sample to extend the training data of the second feature extraction model, thereby improving an extraction effect of the second feature extraction model.

For example, still using FIG. 7 as an example, after inputting the first anchor text sample, the first positive text sample, and the first negative text sample into the text feature extraction branch 701 to obtain the sample feature of the first anchor text sample, the sample feature of the first positive text sample, and the sample feature of the first negative text sample, in addition to calculating the foregoing first loss function value, the computer device may further calculate the second loss function value based on each of the sample feature of the first anchor text sample, the sample feature of the first positive text sample, and the sample feature of the first negative text sample in a contrastive learning mode, and update a parameter of the second feature extraction model through the second loss function value, for example, update a parameter of a text feature extraction branch in the second feature extraction model through the second loss function value.

In a possible implementation, the foregoing method further includes:
a second anchor image-text sample, a second positive image-text sample, and a second negative image-text sample are constructed based on the second image-text data sample, where the second image-text data sample includes at least one second image sample and at least two text samples that are in different languages and that correspond to the second image sample, and the at least two text samples that are in different languages and that correspond to the second image sample are translations of each other, each of the second anchor image-text sample, the second positive image-text sample, and the second negative image-text sample includes an image-text pair, the second anchor image-text sample, the second positive image-text sample, and the second negative image-text sample include the same second image, text in the second positive image-text sample and text in the second anchor image-text sample separately semantically match the second image, and text in the second negative image-text sample does not semantically match the second image;
the second anchor image-text sample, the second positive image-text sample, and the second negative image-text sample are input into the second feature extraction model to obtain a sample feature of the second anchor image-text sample, a sample feature of the second positive image-text sample, and a sample feature of the second negative image-text sample;
a third loss function value is generated based on the sample feature of the second anchor image-text sample, the sample feature of the second positive image-text sample, and the sample feature of the second negative image-text sample; and
a parameter of the second feature extraction model is updated through the third loss function value.

In this aspect of this disclosure, in addition to training the second feature model through the weakly-aligned first image-text data sample, the computer device may further train the second feature model through a strictly-aligned second image-text data sample, where a process of training the second feature model through the second image-text data sample reduces a process of calculating the semantic relevance loss function value compared with a process of training the second feature model through the weakly-aligned first image-text data sample, where the process of calculating the foregoing third loss function value is similar to the process of calculating the first contrastive learning loss function value, and details are not described herein again.

In this aspect of this disclosure, a second machine learning model may be trained by using a regularized cross-lingual visio-textual contrastive learning (R-XVtCL) task based on multi-lingual image-text weakly-aligned image-text pair data set (that is, the foregoing first image-text data sample, represented as D_{w}). For example, the task may further relate to a multi-lingual image-text weakly-aligned image-text pair data set (that is, the foregoing first image-text data sample, represented as Dₛ).

For example, in this aspect of this disclosure, the second machine learning model may be trained through a cross-lingual textual contrastive learning (XTCL) task.

An objective of the XTCL task is to obtain a meaningful textual representation (TR) for multi-lingual text in a UTRS. In this UTRS, TRs with relatively high semantic relevance are relatively close to each other. Otherwise, the TRs with relatively low semantic relevance are relatively far away from each other. In this disclosure, contrastive learning is performed in the UTRS, so that the model can generate a representation satisfying a property.

For example, a multi-lingual text data set Dt including a large-scale parallel pair is given, and a batch

$${B}_{t} = \{ {( {x}_{b}^{{l}_{i}} , {x}_{b}^{{l}_{j}} )}_{b = 1}^{\vert {B}_{t} \vert} \} ( {l}_{i} \neq {l}_{j} )$$

is sampled from the multi-lingual text data set. For a parallel sentence pair (x^{l}^{ᵢ}, x^{l}^{ⱼ}) in Bₜ, a TR of x^{l}^{ᵢ} is used as an anchor in the UTRS, represented as tr*. Because text semantics expressed by x^{l}^{ᵢ} and x^{l}^{ᵢ} are the same, the TR tr⁺ corresponding to the tr* is used as a positive sample for the tr* in the UTRS, and the TR tr⁻(x⁻) of another sentence x⁻ from the same batch is used as a negative sample. Therefore, an objective function of XTCL may be written as:

$${L}_{xtcl} ( {x}^{{l}_{i}} ) = - log \frac{exp ( - {d}_{tr}^{+} )}{exp ( - {d}_{tr}^{+} ) + {\sum }_{{x}^{′} ∈ N ( {x}^{{l}_{i}} )} exp ( - {d}_{tr}^{-} ( {x}^{′} ) )}$$

where N(x^{l}^{ᵢ}) represents a negative sample set for x^{l}^{ᵢ},

$${d}_{tr}^{+}$$

and

$${d}_{tr}^{-} ( {x}^{-} )$$

separately represent Euclidean distances from a positive representation tr⁺ and a negative representation tr⁻(x⁻) to the anchor representation tr* in the UTRS.

In an R-XVtCL task in a pre-training stage, in addition to measuring a similarity between a positive sample and the anchor and a similarity between a negative sample and the anchor by using the Euclidean distances, another text relevance measurement means may be used, for example, a cosine similarity between representation feature vectors, that is, the foregoing Euclidean distance may be replaced with the cosine similarity.

The negative representation obtained in the foregoing mode has insufficient difficulty for a model to perform contrastive learning training, and the model cannot learn an effective TR having a larger amount of information in the UTRS. In this case, in the solution shown in this aspect of this disclosure, a negative sample that is more difficult and that has higher difficulty to distinguish may be generated by a smooth linear interpolation-based negative representation generation method, for example, for a negative sample x⁻ belonging to N (x^{l}^{ᵢ}), the TR tr⁻(x⁻) of the negative sample x⁻ is converted into a negative TR [symbol] ⁻(x⁻) that is more difficult for tr* in the UTRS by interpolating with the anchor representation tr*. Referring to a schematic diagram of a smooth linear interpolation method shown in FIG. 8, a specific construction mode may be written as the following formula:

$$\tilde{{tr}^{-}} = ( {x}^{-} ) = \{ \begin{matrix}{tr}^{*} + λ ( {tr}^{-} ( {x}^{′} ) - {tr}^{*} ) , λ ∈ ( \frac{{d}_{tr}^{+}}{{d}_{tr}^{-} ( {x}^{′} )} , 1 ] & if {d}_{tr}^{-} ( {x}^{′} ) > {d}_{tr}^{+} \\ {tr}^{-} ( {x}^{′} ) , & if {d}_{tr}^{-} ( {x}^{′} ) \leq {d}_{tr}^{+}\end{matrix}$$

In the foregoing formula, A is calculated according to the following formula:

$$λ = {( \frac{{d}_{t r}^{+}}{{d}_{tr}^{-} ( {x}^{′} )} )}^{ζ \cdot {p}_{avg}^{+}} , ζ ∈ ( 0 , 1 )$$

where ζ is a preset scaling coefficient,

$${p}_{avg}^{+} = \frac{1}{100} {\sum }_{τ ∈ [ - 100 , - 1 ]} {e}^{- {L}_{xtcl}^{( τ )}}$$

is an average probability value obtained by calculating log-probability

$${L}_{xtcl}^{( τ )}$$

obtained in 100 operations before the current training operation. The significance of this interpolation mode is that when the difficulty of the negative sample is excessively low,

$${p}_{avg}^{+}$$

may increase, λ is reduced accordingly, and a negative sample [symbol] ⁻(x^{l}^{ⱼ}) that is more difficult relative to tr⁻(x^{l}^{ⱼ}) is brought, so that the model can learn a more meaningful image-text representation in the UTRS.

An objective of the R-XVtCL task is to enable the model to learn a meaningful representation in a UVtRS for multi-lingual visio-textual input through contrastive learning.

For ease of understanding, first, considering that contrastive learning is performed on strictly-aligned multi-lingual image-text pair data, a batch of bilingual parallel visio-textual triples

$${B}_{vt} = \{ {( {v}_{b} , {x}_{b}^{{l}_{i}} , {x}_{b}^{{l}_{j}} )}_{b = 1}^{\vert {B}_{vt} \vert} \} ( {l}_{i} \neq {l}_{j} )$$

from Dₛ is given. For a triple (v, x^{l}^{ᵢ}, x^{l}^{ⱼ}), x^{l}^{ᵢ}, x^{l}^{ⱼ} are separately concatenated with v, a representation after a concatenation (v, x^{l}^{ᵢ}) is input into a model encoder is used as an anchor representation vtr* in the UVtRS, and (v, x^{l}^{ⱼ}) and (v, x^{l}^{ᵢ}) represent the same visio-textual semantics, the visio-textual representation vtr⁺ of the (v, x^{l}^{ⱼ}) may be used as a positive sample to be drawn closer with vtr*. For construction of the negative sample, in this disclosure, another multi-lingual visio-textual triple (\hat{v}, \hat{x}^{l}^{ᵢ}, \hat{x}^{l}^{ⱼ}) in the same training batch Bᵥₜ is used for constructing. There are the following three types of negative samples in total: (1) the negative sample is the same as an (v, x^{l}^{ᵢ}) image input, but a text input is from descriptive text from another image \hat{x}, that is, (v, \hat{x}^{l}^{ᵢ}) and (v, \hat{x}^{l}^{ⱼ}); (2) the negative sample is different from a (v, x^{l}^{ᵢ}) image, but a text input is descriptive text from v, that is, (\hat{v}, x^{l}^{ᵢ}) and (\hat{v}, x^{l}^{ⱼ}); and (3) the negative sample is different from sources of an image and text of (v, x^{l}^{ᵢ}), that is, (\hat{v}, \hat{x}^{l}^{ᵢ}) and (\hat{v}, \hat{x}^{l}^{ⱼ}). With the foregoing positive sample and negative sample, in this disclosure, contrastive learning is performed in the UVtRS in a smooth line interpolation mode similar to that in a previous pre-training task, and an objective function may be written as:

$${\tilde{L}}_{xvtcl} ( v , {x}^{{l}_{i}} ) = - log \frac{exp ( - {d}_{vtr}^{+} )}{exp ( - {d}_{vtr}^{+} ) + {\sum }_{( {v}^{′} , {x}^{′} ) ∈ N ( v , {x}^{{l}_{i}} )} exp ( - {\tilde{d}}_{vtr}^{-} ( {v}^{′} , {x}^{′} ) )}$$

where N (v′, x^{l}^{ⱼ}) is a set including the foregoing three constructed negative samples,

$${d}_{vtr}^{+} and {\tilde{d}}_{vtr}^{-} ( {v}^{′} , {x}^{′} )$$

represent Euclidean distances from the positive representation vtr⁺ and an interpolated representation [symbol] ⁻(v′, x^{l}^{ⱼ}) corresponding to each negative representation (v′, x^{l}^{ⱼ}) to the anchor representation vtr* in the UVtRS.

However, in the foregoing process of performing contrastive learning by using “Strictly-aligned” image-text data, we consider vtr⁺as a representation that needs to be drawn closer with the vtr*. However, this relationship may generate a deviation in data only satisfying a “Weakly-aligned” relationship, that is, semantics of descriptive text that is in different languages and that corresponds to the same image may be related but not equivalent to some extent. In this case, simply and directly drawing vtr⁺ and vtr* closer is improper. In this way, we need to measure a semantic similarity between pieces of multi-lingual text to more effectively capture a semantic relationship between the pieces of multi-lingual text in the UVtRS, thereby obtaining a better visio-textual representation. Therefore, on “Weakly-aligned” multi-lingual image-text data, this disclosure additionally constrains the foregoing contrastive learning process by using text semantic relevance between pieces of multi-lingual descriptive text. The semantic relevance degree between any two segments of text is measured in this disclosure by using a Euclidean distance, learned from an XVTCL task, between TRs in the UTRS. That is, a smaller corresponding distance indicates higher relevance between text semantics.

For example, two multi-lingual visio-textual triples (v, x^{l}^{ᵢ}, x^{l}^{ⱼ}) and (\hat{v}, \hat{x}^{l}^{ᵢ}, \hat{x}^{l}^{ⱼ}) in a batch of bilingual parallel visio-textual triples from D_{w} are given, first, for (x^{l}^{ᵢ}, x^{l}^{ⱼ}) and \hat{x}^{l}^{ᵢ}, \hat{x}^{l}^{ⱼ}), Euclidean distances between each of x^{l}^{ⱼ}, \hat{x}^{l}^{ᵢ}, and \hat{x}^{l}^{ⱼ} and the TR of the x^{l}^{ᵢ} in the UTRS are calculated, which are respectively represented as dₜᵣ(x^{l}^{ⱼ}), dₜᵣ(\hat{x}^{l}^{ᵢ}), and dₜᵣ(\hat{x}^{l}^{ⱼ}). Then, the semantic relevance between x^{l}^{ⱼ}, \hat{x}^{l}^{ᵢ}, and \hat{x}^{l}^{ⱼ} and x^{l}^{ᵢ} may be measured as -dₜᵣ(x^{l}^{ⱼ}), -dₜᵣ(x^{l}^{ᵢ}), and -dₜᵣ(\hat{x}^{l}^{ⱼ}). A larger value indicates higher relevance. Next, -dₜᵣ(x^{l}^{ⱼ}), -dₜᵣ(\hat{x}^{l}^{ᵢ}), and -dₜᵣ(\hat{x}^{l}^{ⱼ}) are normalized into a relevance distribution Pₜᵣ in the UTRS, where

$${P}_{tr} = softmax ( [ - {d}_{tr} ( {x}^{{l}_{j}} ) , - {d}_{tr} ( {\hat{x}}^{{l}_{i}} ) , - {d}_{tr} ( {\hat{x}}^{{l}_{j}} ) ] )$$

Meanwhile, an image-text pair which has the same image input as but has different descriptive text from (v, x^{l}^{ᵢ}) is selected, including (v, x^{l}^{ⱼ}), (v, \hat{x}^{l}^{ᵢ}), and (v, \hat{x}^{l}^{ⱼ}). Similarly, respective visio-textual representations are calculated, and Euclidean distances between the visio-textual representations and a representation of (v, x^{l}^{ᵢ}) in the UVtRS space are obtained, respectively represented as dᵥₜᵣ(v, x^{l}^{ⱼ}), dᵥₜᵣ(v, \hat{x}^{l}^{ᵢ}), dᵥₜᵣ(v, \hat{x}^{l}^{ⱼ}). Then, normalization is performed in a similar mode to obtain a relevance distribution Pᵥₜᵣ in the UVtRS, where

$${P}_{vtr} = softmax ( [ - {d}_{vtr} ( v , {x}^{{l}_{j}} ) , - {d}_{vtr} ( v , {\hat{x}}^{{l}_{i}} ) , - {d}_{vtr} ( v , {\hat{x}}^{{l}_{j}} ) ] )$$

Then, the foregoing two distributions are drawn closer by using a KL divergence, and are trained together with a conventional contrastive learning objective, that is, R-XVtCL, which may be represented as:

$${\tilde{L}}_{xvtcl}^{reg} ( v , {x}^{{l}_{i}} ) = {\tilde{L}}_{xvtcl} ( v , {x}^{{l}_{i}} ) + KL ( {P}_{vtr} \vert \vert {P}_{tr} )$$

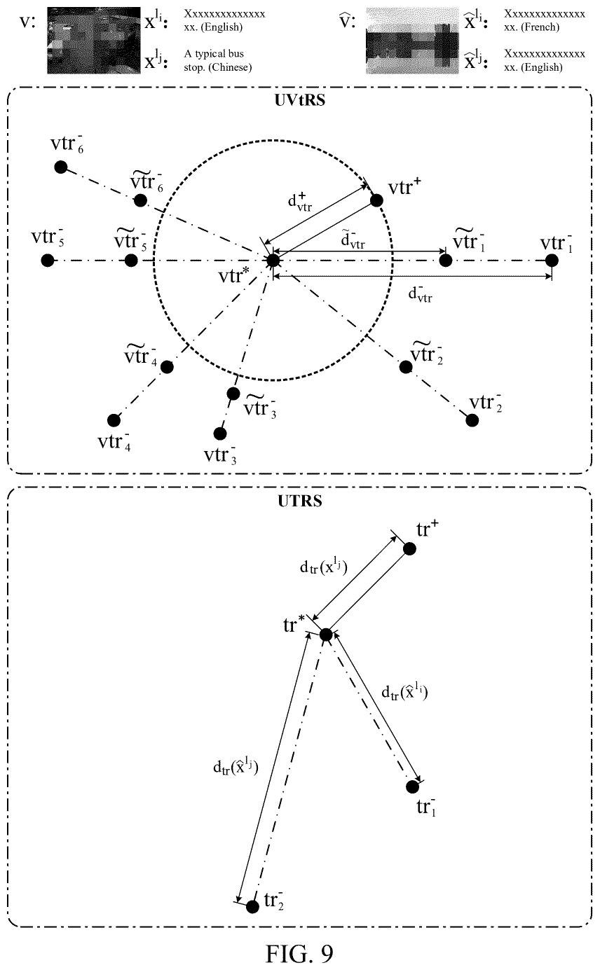

Finally, combining training examples from Dₛ and D_{w}, as a schematic diagram of R-XVtCL shown in FIG. 9, a training objective of the R-XVtCL may be written in the following form:

$${L}_{R - XVtCL} = {E}_{( v , {x}^{{l}_{i}} , {x}^{{l}_{j}} ) ∼ {D}_{s}} {\tilde{L}}_{xtcl} ( {x}^{{l}_{i}} ) + {E}_{( v , {x}^{{l}_{i}} , {x}^{{l}_{j}} ) ∼ {D}_{w}} {\tilde{L}}_{xvtcl}^{reg} ( v , {x}^{{l}_{i}} )$$

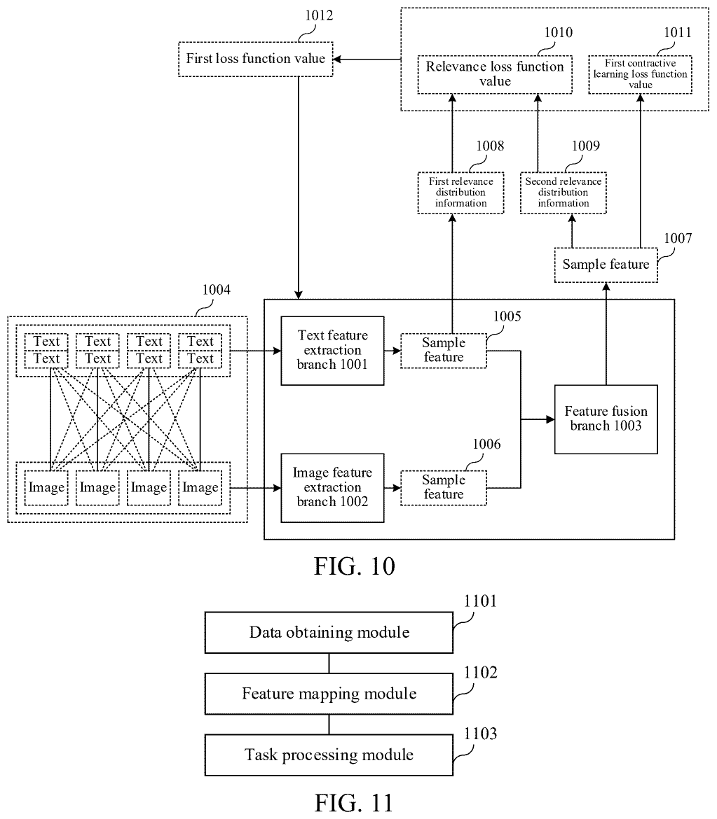

FIG. 10 shows a schematic diagram of a network structure of a second feature extraction model involved in an aspect of this disclosure. In the process of training a second feature model based on weakly-aligned image-text data sample, as shown in FIG. 10, the second feature extraction model is divided according to functions, and may be divided into a text feature extraction branch 1001, an image feature extraction branch 1002, and a feature fusion branch 1003. That a computer device pre-collects an image-text data sample 1004 including a weakly-aligned first image-text data sample, and constructs an input sample based on the image-text data samples 1004 includes: a first anchor image-text sample, a first anchor text sample, a first positive image-text sample, a first positive text sample, a first negative image-text sample, and a first negative text sample are constructed based on the first image-text data.

Then, the computer device inputs text in a constructed input sample into the text feature extraction branch 1001 to obtain a sample feature 1005 of the input text, including sample features of the first anchor text sample, the first positive text sample, and the first negative text sample; and an image in the text in the constructed input sample is input into the image feature extraction branch 1002 to obtain a sample feature 1006 of the input image. The sample feature 1005 and the sample feature 1006 are input into the feature fusion branch 1003 to obtain a sample feature 1007, including sample features of the first anchor image-text sample, the first positive image-text sample, the first positive text sample, and the first negative image-text sample.

Then, according to an aspect, the computer device generates first relevance distribution information 1008 through the sample feature 1007, generates second relevance distribution information 1009 through the sample feature 1006, and generates a relevance loss function value 1010 according to the first relevance distribution information 1008 and the second relevance distribution information 1009. According to another aspect, the computer device generates a first contrastive learning loss function value 1011 through the sample feature 1007, and then generates a first loss function value 1012 through the relevance loss function value 1010 and the first contrastive learning loss function value 1011. Finally, the computer device updates a parameter of the second feature extraction model through the first loss function value 1012.

In a possible implementation, the method further includes:
the first image-text sample and a translation annotation of the first image-text sample are constructed based on a third image-text data sample, where the third image-text data sample includes at least one third image sample and at least two text samples that are in different languages and that correspond to the third image sample, the at least two text samples that in different languages and that correspond to the second image sample are translations of each other, the first image-text sample includes the third image sample and a text sample corresponding to the first image sample, and the translation annotation includes another type of text sample corresponding to the third image sample;
after a text sample part in the first image-text sample is obscured, the text sample part is input into the second feature extraction model to obtain the first sample feature and the second sample feature of the first image-text sample that are output by the second feature extraction model;
the first sample feature is input into a first output network to obtain a first prediction result output by the first output network, where the first prediction result is configured for indicating prediction text of an obscured part of the text sample in the first image-text sample;
the second sample feature is input into a second output network to obtain a second prediction result output by the second output network, where the second prediction result is configured for indicating prediction text of the translation annotation;
a fourth loss function value is generated based on the first prediction result and the obscured part of the text sample in the first image-text sample;
a fifth loss function value is generated based on the second prediction result and the translation annotation; and
the parameter of the second feature extraction model is updated based on the fourth loss function value and the fifth loss function value.

In this aspect of this disclosure, the computer device updates the parameter of the second feature extraction model with reference to a translation task of an image, to extend training data and a training mode of the second feature extraction model, and improve an extraction effect of the second feature extraction model.

In this aspect of this disclosure, the foregoing second feature extraction model may further be trained through a masked conditional language model (MCLM) training task.

The MCLM includes a standard masked language modelling (MLM) task at a source language encoder end and a conditional language modeling (CLM) task at a target language decoder end. An image v and image descriptive text x^{l}^{ᵢ} and x^{l}^{ⱼ} that respectively belong to a language lᵢ and a language lⱼ are given, each word in x^{l}^{ᵢ} has a probability of 15% of being replaced with a special [MASK] marker. At the encoder end, a training objective of the MLM is to predict all masked words

$${x}_{m}^{{l}_{i}}$$

based on the image v and an unmasked word

$${x}_{∖ m}^{{l}_{i}}$$

in x^{l}^{ᵢ}, which may be written in the following form:

$${L}_{MLM} = - {E}_{( v , {x}^{{l}_{i}} ) ∼ {D}_{s}} log {P}_{{θ}_{e}} ( {x}_{m}^{{l}_{i}} \vert {x}_{∖ m}^{{l}_{i}} , v )$$

where Dₛ represents a multi-lingual image-text strictly-aligned image-text pair data set, and θₑ represents a trainable parameter of a model encoder. At the decoder end, in this disclosure, the model is trained to decode to generate x^{l}^{ⱼ} in an autoregressive mode through a CLM objective based on a visio-textual input at an encoder end. A form may be written as:

$${L}_{CLM} = - {E}_{( v , {x}^{{l}_{i}} , {x}^{{l}_{j}} ) ∼ {D}_{s}} {{\sum }_{t = 1}}^{\vert {x}^{{l}_{j}} \vert} log {P}_{{θ}_{d}} ( {x}_{t}^{{l}_{j}} \vert {x}_{< t}^{{l}_{j}} , {x}_{∖ m}^{{l}_{i}} , v )$$

where θ_{d} represents a trainable parameter of a model decoder. With reference to objectives at both ends of the encoder and the decoder, a total MCLM objective may be written as: L_{MCLM}=Lₘₗₘ+L_{clm}.

In a possible implementation, the method further includes:
a third positive image-text sample and a third negative image-text sample are obtained, where the third positive image-text sample includes a semantically matched image-text pair, and the third negative image-text sample includes a semantically mismatched image-text pair;
the third positive image-text sample and the third negative image-text sample are input into the second feature extraction model to obtain a sample feature of the third positive image-text sample and a sample feature of the third negative image-text sample that are output by the second feature extraction model;
the sample feature of the third positive image-text sample and the sample feature of the third negative image-text sample are input into a third output network to obtain a semantic matching probability of the third positive image-text sample and a semantic matching probability of the third negative image-text sample that are output by the third output network;
a sixth loss function value is generated based on the semantic matching probability of the third positive image-text sample and the semantic matching probability of the third negative image-text sample; and
the parameter of the second feature extraction model is updated based on the sixth loss function value.

In this aspect of this disclosure, the second feature extraction model may alternatively be trained through an image-text matching (ITM) task.

In this aspect of this disclosure, the computer device updates a parameter of the second feature extraction model with reference to an image-text matching degree prediction task to extend training data and a training mode of the second feature extraction model, and improve an extraction effect of the second feature extraction model.

An objective of the ITM task is to determine whether a given image input v and text input x^{l} are matched image-text pair, and an objective function may be written as:

$${L}_{ITM} = - {E}_{( v , {x}^{l} ) ∼ {D}_{s}} [ y log {s}_{{θ}_{e}} ( v , {x}^{l} ) + ( 1 - y ) log ( 1 - {s}_{{θ}_{e}} ( v , {x}^{l} ) ) ]$$

where y∈{0, 1} represents whether the text x^{l} and the image v are matched, and See is a fraction ranging from o to 1 obtained after concatenating and inputting v and x^{l} input into the model encoder and enabling a last layer representation corresponding to a first marker [CLS] to pass through a fully connected linear mapping layer and a sigmoid activation layer. The positive sample is image-text strictly-aligned image and text. The negative sample is an image-text pair that is selected in various manners from the same training batch and that does not have an alignment relationship.

That is, the foregoing aspect of this disclosure provides a pretraining framework that more effectively uses a large amount of multi-lingual image-text weakly-aligned multi-modal data. The overall training process may include four pretraining objectives, that is, MCLM, ITM, XTCL, and R-XVtCL.

FIG. 11 is a block diagram of an image-text data processing apparatus according to an aspect of this disclosure. The apparatus may be configured to perform all or some operations of the method shown in FIG. 4, FIG. 5, or FIG. 6. As shown in FIG. 11, the apparatus includes:
a data obtaining module 1101, configured to obtain first image-text data, where the first image-text data includes at least one image and at least one piece of text;
a feature mapping module 1102, configured to perform feature extraction on the first image-text data to map the first image-text data to a UVtRS to obtain a data feature of the first image-text data, where the UVtRS is a feature space that is constructed based on a first image-text data sample and by using semantic relevance between pieces of text in the first image-text data sample as a constraint, the first image-text data sample includes at least one first image sample and at least two text samples that are in different languages and that correspond to the first image sample, and the at least two text samples that are in different languages and that correspond to the first image sample are not translations of each other; and
a task processing module 1103, configured to send the data feature of the first image-text data to a task processing component, and output, by the task processing component, a processing result of a target task based on the data feature, where the target task is a classification or regression task based on image-text data.

In a possible implementation, the feature mapping module 1102 is configured to:
input the first image-text data into a first feature extraction model to obtain the data feature of the first image-text data output by the first feature extraction model, where
the first feature extraction model is a machine learning network constructed based on a second feature extraction model, and the second feature extraction model is a machine learning model obtained by performing machine learning training based on the first image-text data sample and by using the semantic relevance between the pieces of text in the first image-text data sample as the constraint.

In a possible implementation, the apparatus further includes: a model training module, configured to:
construct a first anchor sample, a first positive sample, and a first negative sample based on a first image-text data sample;
input the first anchor sample, the first positive sample, and the first negative sample into the second feature extraction model to obtain a first sample feature output by the second feature extraction model;
obtain a first loss function value based on the first sample feature and by using semantic relevance between pieces of text in the first image-text data sample as a constraint; and
update a parameter of the second feature extraction model through the first loss function value.

In a possible implementation, the first anchor sample includes a first anchor image-text sample and a first anchor text sample. The first positive sample includes at least one first positive image-text sample and at least one first positive text sample. The first negative sample includes at least one first negative image-text sample and at least one first negative text sample.

Each of the first anchor image-text sample, the first positive image-text sample, and the first negative image-text sample includes an image-text pair, and the first anchor image-text sample, the first positive image-text sample, and the first negative image-text sample include the same first image. Text in the first positive image-text sample and text in the first anchor image-text sample separately semantically match the first image, and text in the first negative image-text sample does not semantically match the first image. The first anchor text sample includes text in the first anchor image-text sample, the first positive text sample comprises the text in the first positive image-text sample, and the first negative text sample includes the text in the first negative image-text sample.

The model training module is configured to:
input the first anchor image-text sample, the first positive image-text sample, and the first negative image-text sample into the second feature extraction model to obtain a sample feature of the first anchor image-text sample, a sample feature of the first positive image-text sample, and a sample feature of the first negative image-text sample;
input the first anchor text sample, the first positive text sample, and the first negative text sample into the second feature extraction model to obtain a sample feature of the first anchor text sample, a sample feature of the first positive text sample, and a sample feature of the first negative text sample;
obtain semantic relevance information based on the sample feature of the first anchor image-text sample, the sample feature of the first positive image-text sample, the sample feature of the first negative image-text sample, the sample feature of the first anchor text sample, the sample feature of the first positive text sample, and the sample feature of the first negative text sample, where the semantic relevance information is configured for indicating the semantic relevance between the pieces of text in the first image-text data sample;
generate a semantic relevance loss function value based on the semantic relevance information;
generate a first contrastive learning loss function value based on the sample feature of the first anchor image-text sample, the sample feature of the first positive image-text sample, and the sample feature of the first negative image-text sample; and
obtain the first loss function value based on the semantic relevance loss function value and the first contrastive learning loss function value.

In a possible implementation, the model training module is configured to:
perform normalization processing on the sample feature of the first anchor image-text sample, the sample feature of the first positive image-text sample, and the sample feature of the first negative image-text sample to obtain first relevance distribution information in the semantic relevance information;
perform normalization processing on the sample feature of the first anchor text sample, the sample feature of the first positive text sample, and the sample feature of the first negative text sample to obtain second relevance distribution information in the semantic relevance information; and
calculate a KL divergence for the first relevance distribution information and the second relevance distribution information to obtain the semantic relevance loss function value.

In a possible implementation, the model training module is configured to:
generate a second loss function value based on the sample feature of the first anchor text sample, the sample feature of the first positive text sample, and the sample feature of the first negative text sample; and
update the parameter of the second feature extraction model by using the second loss function value.

In a possible implementation, the model training module is configured to:
construct a second anchor image-text sample, a second positive image-text sample, and a second negative image-text sample based on the second image-text data sample, where the second image-text data sample includes at least one second image sample and at least two text samples that are in different languages and that correspond to the second image sample, the at least two text samples that are in different languages and that correspond to the second image sample are translations of each other, each of the second anchor image-text sample, the second positive image-text sample, and the second negative image-text sample includes an image-text pair, the second anchor image-text sample, the second positive image-text sample, and the second negative image-text sample includes the same second image, text in the second positive image-text sample and text in the second anchor image-text sample separately semantically match the second image, and text in the second negative image-text sample does not semantically match the second image;
input the second anchor image-text sample, the second positive image-text sample, and the second negative image-text sample into the second feature extraction model to obtain a sample feature of the second anchor image-text sample, a sample feature of the second positive image-text sample, and a sample feature of the second negative image-text sample;
generate a third loss function value based on the sample feature of the second anchor image-text sample, the sample feature of the second positive image-text sample, and the sample feature of the second negative image-text sample; and
update the parameter of the second feature extraction model through the third loss function value.

In a possible implementation, the model training module is configured to:
construct a first image-text sample and a translation annotation of the first image-text sample based on the third image-text data sample, where the third image-text data sample includes at least one third image sample and at least two text samples that are in different languages and that correspond to the third image sample, the at least two text samples that in different languages and that correspond to the second image sample are translations of each other, the first image-text sample includes the third image sample and a text sample corresponding to the first image sample, and the translation annotation includes another text sample corresponding to the third image sample;
input, after a text sample part in the first image-text sample is obscured, the text sample part into the second feature extraction model to obtain the first sample feature and the second sample feature of the first image-text sample that are output by the second feature extraction model;
input the first sample feature into a first output network to obtain a first prediction result output by the first output network, where the first prediction result is configured for indicating prediction text of an obscured part of the text sample in the first image-text sample;
input the second sample feature into a second output network to obtain a second prediction result output by the second output network, where the second prediction result is configured for indicating prediction text of the translation annotation;
generate a fourth loss function value based on the first prediction result and the obscured part of the text sample in the first image-text sample;
generate a fifth loss function value based on the second prediction result and the translation annotation; and
update the parameter of the second feature extraction model based on the fourth loss function value and the fifth loss function value.

In a possible implementation, the model training module is configured to:
obtain a third positive image-text sample and a third negative image-text sample, where the third positive image-text sample includes a semantically matched image-text pair, and the third negative image-text sample includes a semantically mismatched image-text pair;
input the third positive image-text sample and the third negative image-text sample into the second feature extraction model to obtain a sample feature of the third positive image-text sample and a sample feature of the third negative image-text sample that are output by the second feature extraction model;
input the sample feature of the third positive image-text sample and the sample feature of the third negative image-text sample into a third output network to obtain a semantic matching probability of the third positive image-text sample and a semantic matching probability of the third negative image-text sample that are output by the third output network;
generate a sixth loss function value based on the semantic matching probability of the third positive image-text sample and the semantic matching probability of the third negative image-text sample; and
update the parameter of the second feature extraction model based on the sixth loss function value.

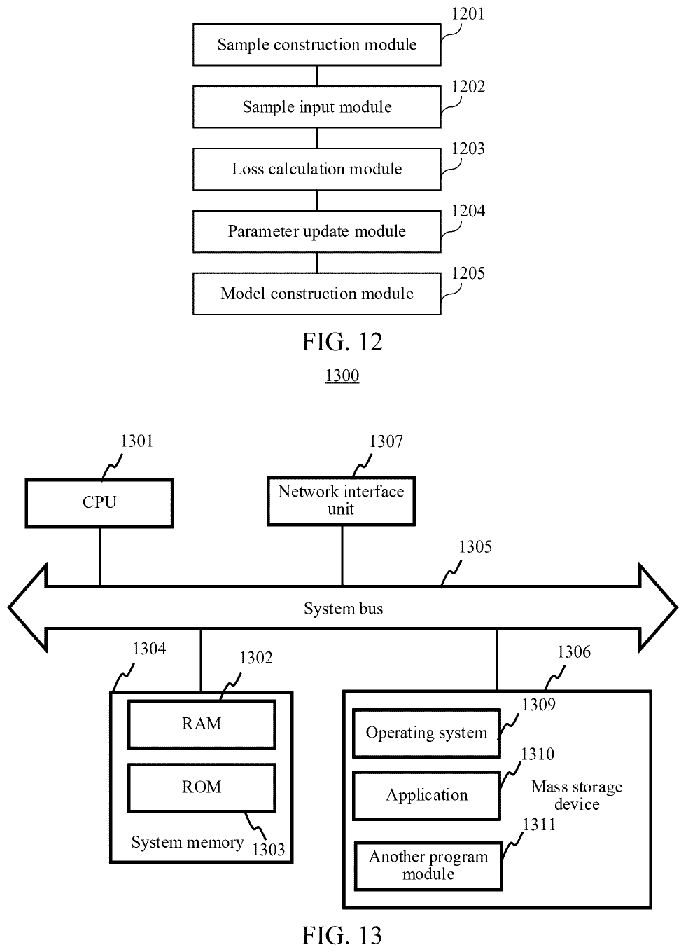

FIG. 12 is a block diagram of an image-text data processing apparatus according to an aspect of this disclosure. The apparatus may be configured to perform all or some operations of the method shown in FIG. 5 or FIG. 6. As shown in FIG. 12, the apparatus includes:
a sample construction module 1201, configured to construct a first anchor sample, a first positive sample, and a first negative sample based on a first image-text data sample, where the first image-text data sample includes at least one first image sample and at least two text samples that are in different languages and that correspond to the first image sample, and the at least two text samples that are in different languages and that correspond to the first image sample are not translations of each other; and
a sample input module 1202, configured to input the first anchor sample, the first positive sample, and the first negative sample into a second feature extraction model to obtain a first sample feature output by the second feature extraction model;
a loss calculation module 1203, configured to obtain a first loss function value based on the first sample feature and by using semantic relevance between pieces of text in the first image-text data sample as a constraint;
a parameter update module 1204, configured to update a parameter of the second feature extraction model through the first loss function value; and
a model construction module 1205, configured to construct a first feature extraction model based on the second feature extraction model in response to that the second feature extraction model meets a convergence condition, where the first feature extraction model is configured to process input first image-text data to obtain a data feature of the first image-text data, a processing result of a target task is output after the data feature of the first image-text data is processed by a task processing component, and the target task is a classification or regression task based on image-text data.

FIG. 13 is a structural block diagram of a computer device 1300 according to an aspect of this disclosure. The computer device may be implemented as a server or a terminal in the foregoing solutions in this disclosure. In this aspect of this disclosure, an example in which the computer device is a server is used for description. The computer device 1300 includes processing circuitry, such as a central processing unit (CPU) 1301, a system memory 1304 including a random access memory (RAM) 1302 and a read-only memory (ROM) 1303, and a system bus 1305 connecting the system memory 1304 and the CPU 1301. The computer device 1300 further includes a mass storage device 1306 configured to store an operating system 1309, an application program 1310, and another program module 1311.

The mass storage device 1306 is connected to the CPU 1301 through a mass storage controller (not shown) connected to the system bus 1305. The mass storage device 1306 and a computer-readable medium associated with the large-capacity storage device provide non-volatile storage for the computer device 1300. That is, the mass storage device 1306 may include a computer-readable medium (not shown) such as a hard disk or a compact disc read-only memory (CD-ROM) drive.

The computer-readable medium may include a computer storage medium such as a non-transitory computer-readable storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, an erasable programmable read-only memory (EPROM), an electrically-erasable programmable read-only memory (EEPROM), a flash memory or another solid-state storage device, a CD-ROM, a digital versatile disc (DVD) or another optical storage, a cartridge, a magnetic tape, a magnetic disk memory, or another magnetic storage device. Certainly, a person skilled in art can know that the computer storage medium is not limited to the foregoing several types. The foregoing system memory 1304 and the mass storage device 1306 may be collectively referred to as a memory.

According to various aspects of the present disclosure, the computer device 1300 may be further connected, through a network such as the Internet, to a remote computer on the network for running. That is, the computer device 1300 may be connected to the network through a network interface unit 1307 connected to the system bus 1305, or may be connected to another type of network or a remote computer system (not shown) through the network interface unit 1307.

The memory further includes at least one computer program. The at least one computer program is stored in a memory. The CPU 1301 executes the at least one computer program to implement all or some of the operations in the method shown in various aspects described above.

In an aspect, a computer-readable storage medium is further provided, and is configured to store at least one computer program. The at least one computer program is loaded and executed by a processor to implement all or some of the operations in the method shown in various aspects described above. For example, the computer-readable storage medium may be a read-only memory (ROM), a random access memory (RAM), a compact disc read-only memory (CD-ROM), a magnetic tape, a floppy disk, an optical data storage device, and the like.

In an aspect, a computer program product is further provided. The computer program product includes a computer program. The computer program is stored in a computer-readable storage medium. A processor of a computer device reads the computer program from the computer-readable storage medium, and the processor executes the computer program, so that the computer device performs all or some of the operations in the method shown in various aspects described above.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. A method for training an image-text data feature extraction model, the method comprising:
obtaining first image-text data that includes at least one first image sample and at least two text samples in different languages corresponding to the at least one first image sample, the at least two text samples including unrelated content;
constructing, from the first image-text data, training samples including an anchor sample, at least one positive sample corresponding to a translation of the anchor sample, and at least one negative sample including content that is unrelated to content of the anchor sample;
inputting the training samples into a second feature extraction model to obtain sample features;
generating (i) a first loss value that is based on a semantic relevance loss with semantic relevance between the at least two text samples in the first image-text data as a semantic relevance constraint and (ii) a contrastive learning loss obtained from the sample features;
updating at least one parameter of the second feature extraction model based on the first loss value; and
in response to a convergence condition of the second feature extraction model being satisfied, constructing a first feature extraction model from the updated second feature extraction model, the first feature extraction model being configured to map image-text data into a universal visio-textual representation space (UVtRS).

2. The method according to claim 1, wherein the constructing the training samples comprises:
constructing the anchor sample, a first positive sample of the at least one positive sample, and a first negative sample of the at least one negative sample based on the first image-text data, wherein the first positive sample has higher semantic similarity to the anchor sample than the first negative sample.

3. The method according to claim 2, wherein
the anchor sample includes a first anchor image-text sample and a first anchor text sample, the first positive sample includes at least one first positive image-text sample and at least one first positive text sample, and the first negative sample includes at least one first negative image-text sample and at least one first negative text sample;
each of the first anchor image-text sample, the at least one first positive image-text sample, and the at least one first negative image-text sample includes an image-text pair including a first image selected from the at least one first image sample;
text in the at least one first positive image-text sample and text in the first anchor image-text sample separately semantically match the first image; and
text in the at least one first negative image-text sample does not semantically match the first image;
the first anchor text sample includes the text in the first anchor image-text sample;
the at least one first positive text sample includes the text in the at least one first positive image-text sample; and
the at least one first negative text sample includes the text in the at least one first negative image-text sample.

4. The method according to claim 3, wherein
the inputting the training samples comprises:
inputting the first anchor image-text sample, the at least one first positive image-text sample, and the at least one first negative image-text sample into the second feature extraction model to obtain a sample feature of the first anchor image-text sample, a sample feature of the at least one first positive image-text sample, and a sample feature of the at least one first negative image-text sample; and
inputting the first anchor text sample, the at least one first positive text sample, and the at least one first negative text sample into the second feature extraction model to obtain a sample feature of the first anchor text sample, a sample feature of the at least one first positive text sample, and a sample feature of the at least one first negative text sample; and
the generating the first loss value comprises:
obtaining semantic relevance information based on the sample feature of the first anchor image-text sample, the sample feature of the at least one first positive image-text sample, the sample feature of the at least one first negative image-text sample, the sample feature of the first anchor text sample, the sample feature of the at least one first positive text sample, and the sample feature of the at least one first negative text sample, the semantic relevance information indicating the semantic relevance between the at least two text samples in the first image-text data;
generating the semantic relevance loss based on the semantic relevance information;
generating the contrastive learning loss based on the sample feature of the first anchor image-text sample, the sample feature of the at least one first positive image-text sample, and the sample feature of the at least one first negative image-text sample; and
obtaining the first loss value based on the semantic relevance loss and the contrastive learning loss.

5. The method according to claim 4, wherein the generating the semantic relevance loss comprises:
performing normalization processing on the sample feature of the first anchor image-text sample, the sample feature of the at least one first positive image-text sample, and the sample feature of the at least one first negative image-text sample to obtain first relevance distribution information in the semantic relevance information; and
performing normalization processing on the sample feature of the first anchor text sample, the sample feature of the at least one first positive text sample, and the sample feature of the at least one first negative text sample to obtain second relevance distribution information in the semantic relevance information; and
calculating a Kullback-Leibler (KL) divergence between the first relevance distribution information and the second relevance distribution information to obtain the semantic relevance loss.

6. The method according to claim 4, further comprising:
generating a second loss value based on the sample feature of the first anchor text sample, the sample feature of the at least one first positive text sample, and the sample feature of the at least one first negative text sample; and
updating the at least one parameter of the second feature extraction model based on the second loss value.

7. The method according to claim 1, further comprising:
obtaining second image-text data including at least one second image sample and at least two text samples in different languages corresponding to the at least one second image sample, the at least two text samples are related to each other;
constructing a second anchor image-text sample, a second positive image-text sample, and a second negative image-text sample based on the second image-text data, each of the second anchor image-text sample, the second positive image-text sample, and the second negative image-text sample including an image-text pair including a second image selected from the at least one second image sample, text in the second positive image-text sample and text in the second anchor image-text sample separately semantically matching the second image, and text in the second negative image-text sample not semantically matching the second image;
inputting the second anchor image-text sample, the second positive image-text sample, and the second negative image-text sample into the second feature extraction model to obtain a sample feature of the second anchor image-text sample, a sample feature of the second positive image-text sample, and a sample feature of the second negative image-text sample;
generating a third loss value based on the sample feature of the second anchor image-text sample, the sample feature of the second positive image-text sample, and the sample feature of the second negative image-text sample through contrastive learning without the semantic relevance constraint; and
updating the at least one parameter of the second feature extraction model based on the third loss value.

8. The method according to claim 1, further comprising:
obtaining third image-text data including at least one third image sample and at least two text samples in different languages corresponding to the at least one third image sample that are related to each other;
constructing a first image-text sample and a translation annotation of the first image-text sample based on the third image-text data, the first image-text sample including the at least one third image sample and a first text sample selected from the at least two text samples corresponding to the at least one third image sample, and the translation annotation including a second text sample selected from the at least two text samples corresponding to the at least one third image sample;
masking a portion of the first text sample in the first image-text sample;
inputting the first image-text sample with the masked portion of the first text sample into the second feature extraction model to obtain a first sample feature and a second sample feature of the first image-text sample through the second feature extraction model;
inputting the first sample feature into a first output network to obtain a first prediction result, the first prediction result indicating prediction text of the masked portion of the first text sample in the first image-text sample;
inputting the second sample feature into a second output network to obtain a second prediction result, the second prediction result indicating prediction text of the translation annotation;
generating a fourth loss value based on the first prediction result and the masked portion of the first text sample in the first image-text sample;
generating a fifth loss value based on the second prediction result and the translation annotation; and
updating the at least one parameter of the second feature extraction model based on the fourth loss value and the fifth loss value.

9. The method according to claim 1, further comprising:
obtaining a third positive image-text sample and a third negative image-text sample, the third positive image-text sample including a semantically matched image-text pair, and the third negative image-text sample including a semantically mismatched image-text pair;
inputting the third positive image-text sample and the third negative image-text sample through the second feature extraction model to obtain a sample feature of the third positive image-text sample and a sample feature of the third negative image-text sample;
inputting the sample feature of the third positive image-text sample and the sample feature of the third negative image-text sample into a third output network to obtain a semantic matching probability of the third positive image-text sample and a semantic matching probability of the third negative image-text sample;
generating a sixth loss value based on the semantic matching probability of the third positive image-text sample and the semantic matching probability of the third negative image-text sample; and
updating the at least one parameter of the second feature extraction model based on the sixth loss value.

10. The method according to claim 4, wherein the generating the contrastive learning loss comprises:
applying smooth linear interpolation to modify the at least one negative sample, the applying comprising:
calculating a negative sample distance between a sample feature of a negative sample of the at least one negative sample and a sample feature of the anchor sample, and calculating a positive sample distance between a sample feature of a positive sample of the at least one positive sample and the sample feature of the anchor sample;
when the negative sample distance exceeds the positive sample distance:
calculating an interpolation parameter based on a ratio of the positive sample distance to the negative sample distance and an average probability value; and
generating an interpolated negative sample by linearly interpolating between the anchor sample and the negative sample using the interpolation parameter, the contrastive learning loss being calculated based on the interpolated negative sample.

11. The method according to claim 5, wherein
the first relevance distribution information includes a visio-textual distribution obtained by normalizing semantic distances between image-text samples with a same image;
the second relevance distribution information includes a textual distribution obtained by normalizing semantic distances between text-only samples; and
calculating the KL divergence comprises computing a KL divergence between the visio-textual distribution and the textual distribution to align semantic relevance measurements across modalities.

12. A method for processing image-text data, the method comprising:
obtaining the image-text data including at least one image and at least one text sample;
inputting the image-text data into a first feature extraction model; and
obtaining a data feature of the image-text data from the first feature extraction model, the data feature being in a universal visio-textual representation space (UVtRS), wherein
the first feature extraction model is trained by:
obtaining first image-text data that includes at least one first image sample and at least two text samples in different languages corresponding to the at least one first image sample, the at least two text samples not being translations of each other;
constructing, from the first image-text data, training samples including an anchor sample, at least one positive sample, and at least one negative sample;
inputting the training samples into a second feature extraction model to obtain sample features;
generating (i) a first loss value that includes a semantic relevance loss using semantic relevance between the at least two text samples in the first image-text data as a semantic relevance constraint and (ii) a contrastive learning loss obtained from the sample features;
updating at least one parameter of the second feature extraction model based on the first loss value; and
in response to a convergence condition being satisfied, constructing the first feature extraction model from the updated second feature extraction model.

13. The method according to claim 12, further comprising:
processing the data feature of the image-text data through a task processing component; and
outputting a processing result of a target task based on the data feature, the target task including a classification task or a regression task based on the image-text data.

14. An apparatus for training an image-text data feature extraction model, the apparatus comprising:
processing circuitry configured to:
obtain first image-text data that includes at least one first image sample and at least two text samples in different languages corresponding to the at least one first image sample, the at least two text samples including unrelated content;
construct, from the first image-text data, training samples including an anchor sample, at least one positive sample corresponding to a translation of the anchor sample, and at least one negative sample including content that is unrelated to content of the anchor sample;
input the training samples into a second feature extraction model to obtain sample features;
generate (i) a first loss value that is based on a semantic relevance loss with semantic relevance between the at least two text samples in the first image-text data as a semantic relevance constraint and (ii) a contrastive learning loss obtained from the sample features;
update at least one parameter of the second feature extraction model based on the first loss value; and
in response to a convergence condition of the second feature extraction model being satisfied, construct a first feature extraction model from the updated second feature extraction model, the first feature extraction model being configured to map image-text data into a universal visio-textual representation space (UVtRS).

15. The apparatus according to claim 14, wherein
the processing circuitry is configured to:
construct the anchor sample, a first positive sample of the at least one positive sample, and a first negative sample of the at least one negative sample based on the first image-text data, and
the first positive sample has higher semantic similarity to the anchor sample than the first negative sample.

16. The apparatus according to claim 15, wherein
the anchor sample includes a first anchor image-text sample and a first anchor text sample, the first positive sample includes at least one first positive image-text sample and at least one first positive text sample, and the first negative sample includes at least one first negative image-text sample and at least one first negative text sample;
each of the first anchor image-text sample, the at least one first positive image-text sample, and the at least one first negative image-text sample includes an image-text pair including a first image selected from the at least one first image sample;
text in the at least one first positive image-text sample and text in the first anchor image-text sample separately semantically match the first image;
text in the at least one first negative image-text sample does not semantically match the first image;
the first anchor text sample includes the text in the first anchor image-text sample;
the at least one first positive text sample includes the text in the at least one first positive image-text sample; and
the at least one first negative text sample includes the text in the at least one first negative image-text sample.

17. The apparatus according to claim 16, wherein the processing circuitry is configured to:
input the first anchor image-text sample, the at least one first positive image-text sample, and the at least one first negative image-text sample into the second feature extraction model to obtain a sample feature of the first anchor image-text sample, a sample feature of the at least one first positive image-text sample, and a sample feature of the at least one first negative image-text sample;
input the first anchor text sample, the at least one first positive text sample, and the at least one first negative text sample into the second feature extraction model to obtain a sample feature of the first anchor text sample, a sample feature of the at least one first positive text sample, and a sample feature of the at least one first negative text sample;
obtain semantic relevance information based on the sample feature of the first anchor image-text sample, the sample feature of the at least one first positive image-text sample, the sample feature of the at least one first negative image-text sample, the sample feature of the first anchor text sample, the sample feature of the at least one first positive text sample, and the sample feature of the at least one first negative text sample, the semantic relevance information indicating the semantic relevance between the at least two text samples in the first image-text data;
generate the semantic relevance loss based on the semantic relevance information;
generate the contrastive learning loss based on the sample feature of the first anchor image-text sample, the sample feature of the at least one first positive image-text sample, and the sample feature of the at least one first negative image-text sample; and
obtain the first loss value based on the semantic relevance loss and the contrastive learning loss.

18. The apparatus according to claim 17, wherein the processing circuitry is configured to:
perform normalization processing on the sample feature of the first anchor image-text sample, the sample feature of the at least one first positive image-text sample, and the sample feature of the at least one first negative image-text sample to obtain first relevance distribution information in the semantic relevance information;
perform normalization processing on the sample feature of the first anchor text sample, the sample feature of the at least one first positive text sample, and the sample feature of the at least one first negative text sample to obtain second relevance distribution information in the semantic relevance information; and
calculate a Kullback-Leibler (KL) divergence between the first relevance distribution information and the second relevance distribution information to obtain the semantic relevance loss.

19. The apparatus according to claim 17, wherein the processing circuitry is configured to:
generate a second loss value based on the sample feature of the first anchor text sample, the sample feature of the at least one first positive text sample, and the sample feature of the at least one first negative text sample; and
update the at least one parameter of the second feature extraction model based on the second loss value.

20. The apparatus according to claim 14, wherein the processing circuitry is configured to:
obtain second image-text data including at least one second image sample and at least two text samples in different languages corresponding to the at least one second image sample, the at least two text samples are related to each other;
construct a second anchor image-text sample, a second positive image-text sample, and a second negative image-text sample based on the second image-text data, each of the second anchor image-text sample, the second positive image-text sample, and the second negative image-text sample including an image-text pair including a second image selected from the at least one second image sample, text in the second positive image-text sample and text in the second anchor image-text sample separately semantically matching the second image, and text in the second negative image-text sample not semantically matching the second image;
input the second anchor image-text sample, the second positive image-text sample, and the second negative image-text sample into the second feature extraction model to obtain a sample feature of the second anchor image-text sample, a sample feature of the second positive image-text sample, and a sample feature of the second negative image-text sample;
generate a third loss value based on the sample feature of the second anchor image-text sample, the sample feature of the second positive image-text sample, and the sample feature of the second negative image-text sample through contrastive learning without the semantic relevance constraint; and
update the at least one parameter of the second feature extraction model based on the third loss value.
